(19) United States
(12) Patent Application Publication
(10) Pub. No.: US 2006/0284737 A1
(43) Pub. Date: Dec. 21, 2006

(54) Device to determine the position of an immobile object

(75) Inventors: Marc Brouant, Marquein (FR); Jean Coutris, Toulouse (FR)

Correspondence Address: OLIFF & BERRIDGE, PLC, P.O. BOX 19928, ALEXANDRIA, VA, 22320, US

(73) Assignee: ARCK SENSOR, Ramonville Saint Agne (FR)

(21) Appl. No.: 11/445,135

(22) Filed: Jun. 2, 2006

(30) Foreign Application Priority Data
Jun. 6, 2005 (FR) 05.05688

(51) Int. Cl. G08G 1/123

(52) U.S. Cl. 340/988

(57) ABSTRACT

A device to determine the position of a mobile object with respect to an immobile object, wherein it comprises means to emit a beam of infrared light fixed on the mobile object to illuminate at least partially the immobile object, means to receive the reflected beam fixed onto the mobile object and means to analyze the reflected beam to delimit its variations in intensity, the emission means being constituted by at least one electroluminescent diode whose beam is focused.

### BACKGROUND OF THE INVENTION

1. Field of the Invention

The technical scope of the present invention is that of devices to determine the position of a mobile object with respect to a fixed point.

2. Description of the Related Art

In the specific area of goods containers, it is well known to provide handling means for these containers positioned on a ship or storage facility. These means generally comprise a crane fitted with a spreader on cables in the form of a frame whose dimensions correspond to those of the upper face of the container and which carries means to hook the spreader in the ISO corners of the container. The operator carrying out this task is not able to distinguish the spreader's position with respect to the container. He thus proceeds by trial and error until the spreader is fully adapted to the container. This way of doing things takes a lot of time and leads to the immobilization of the ship for longer periods. The situation is the same when the container is in the storage facility.

### SUMMARY OF THE INVENTION

The aim of the present invention is to supply a device enabling the position of an immobile object such as a container to be determined with a high level of accuracy using a mobile object such as a spreader, and this very quickly.

The invention thus relates to a device to determine the position of a mobile object with respect to an immobile object, wherein it comprises means to emit a beam of infrared light fixed on the mobile object to illuminate at least partially the immobile object, means to receive the reflected beam fixed onto the mobile object and means to analyze the reflected beam to delimit its variations in intensity.

According to one characteristic, the emission means are constituted by at least one electroluminescent diode whose beam is focused.

According to another characteristic, the beam is angularly offset with respect to the direction perpendicular to the immobile object.

Advantageously, the beam of the electroluminescent diode is focused using a semi-cylindrical lens.

According to another characteristic, the emission means are constituted by a set of electroluminescent diode strips positioned in parallel to one another, a set of lenses being associated with the electroluminescent diodes.

Advantageously, the set of electroluminescent diodes is integral with a support inclined at an angle γ with respect to a horizontal direction delimited by the immobile object, the set of lenses being inclined by the same angle.

Advantageously again, the device comprises a set of electroluminescent diode strips and lenses arranged on both sides of the reception means.

According to another characteristic, the reception means are constituted by a linear photodiode sensor.

Advantageously, the sensor is provided with reception and filtering modules centered on the wavelength of the emission means.

According to yet another characteristic, the means to analyze the reflected beam are able to spot the zones of differing light intensity to detect the presence of the immobile object and its position.

According to yet another characteristic, the emission means are supplied by pulse so as to illuminate the immobile object intermittently.

The invention also relates to a process to implement a device according to the invention, wherein an immobile object is illuminated by means of electroluminescent diodes, the reflected beam is analyzed so as to determine the bands of differing luminosity, the zones of strong luminosity representing the data of the presence of the immobile object are determined, this data is stored in a memory, and the same steps are repeated at several representative points of the immobile object.

One application of the device lies in that the immobile object is a container and in that the mobile object is a spreader in the form of a frame whose dimensions are adapted to those of the container side facing it and in that a device according to the invention is placed on each side of the frame.

A first advantage of the device according to the invention lies in the fact that the detection of the object is made without any contact with the immobile object by simple analysis of a reflected beam.

Another advantage lies in the fact that the device may be integrated in a watertight assembly having no mobile parts thus enabling it to be used in a saline environment.

Another advantage lies in the fact that the device is insensitive to the surface state of the immobile object, be it new, worn, painted or rusted.

Yet another advantage lies in the fact that the system can integrate an automatic analysis function for the light reflected by the environment and thus facilitate detection in all circumstances.

### BRIEF DESCRIPTION OF THE DRAWINGS

Other characteristics, particulars and advantages of the invention will become more apparent from the description given hereafter by way of illustration and with reference to the drawings, in which:

FIG. 1 shows a schematic embodiment of the installation of the device according to the invention,

FIG. 2 shows the light beam emitted by two electroluminescent diodes arranged near to one another,

FIG. 3 shows the form of the beam received by a measurement sensor which will be positioned facing and at a distance from the light emission system in a first direction,

FIG. 4 shows the form of the beam in a direction perpendicular to the first direction,

FIG. 5 is a section view showing the mechanical structure of the device,

FIG. 6 is a section view of a case integrating the device according to the invention, by way of an illustrative embodiment of the device,

FIGS. 7 and 8 show embodiments of the focusing lenses of the emitting beam, and

FIG. 9 shows a block diagram of the organization of the device according to the invention.

### DETAILED DESCRIPTION OF PREFERRED EMBODIMENTS

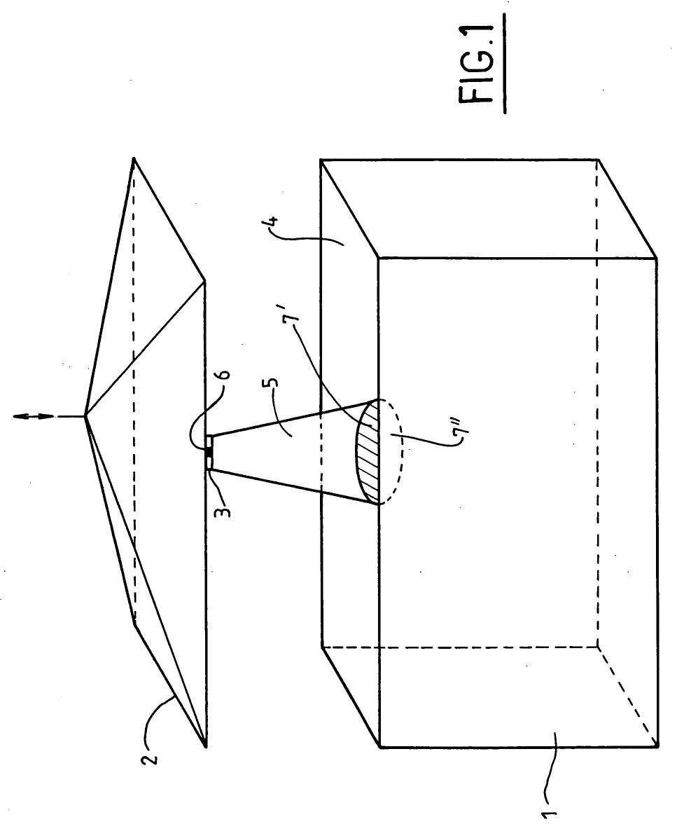

FIG. 1 shows an immobile object 1 that can be a container for example, positioned either on a ship on in a storage facility and which is required to be handled. To this end, this immobile object is taken up by a mobile object 2 in order to move it from one point to another. This mobile object 2 is, for example, a spreader in the form of a frame matching the shape of the upper surface 4 of the container. A device 3 is fixed onto the mobile object to determine the position of this container 1. Preferentially, this device 3 is placed on the external edge of the frame. This device emits a light beam 5 which hits a zone 7′ of the face 4 of the container 1, the other zone 7″ of the beam, represented by dotted lines, corresponds to a dissipation of the light or to a weak reflection by a surface located at a lower level to that of the face 4. Computation means described hereafter enable the separating line between these two distinct reflection zones to be detected and thus enable an edge of face 4 of the container 1 to be determined. By judiciously spacing the sensors 6 on the mobile object 2, we are able to determine the different edges of the container and the mobile object is able to be brought very quickly and accurately above the immobile object thereby enabling precious time to be saved in handling such an object. The invention thus implements the principle of synchronous detection.

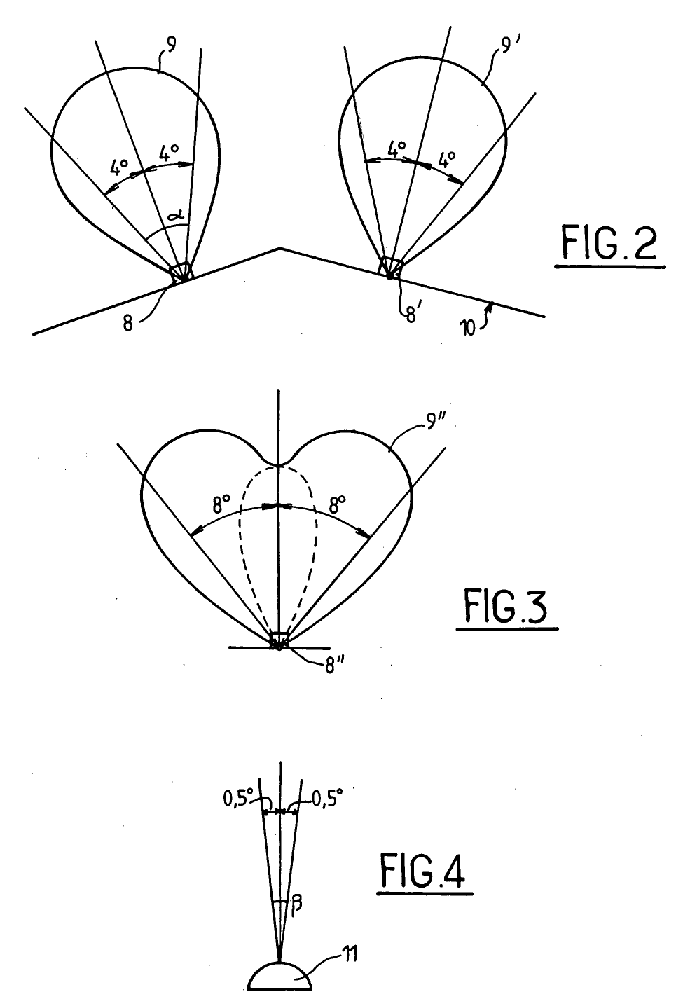

To detect the edge of the immobile object 1, an electroluminescent diode 8 is implemented, as shown in FIG. 2, whose beam 9 delimits a useful angle of around a few degrees. The section shown in this Figure is made along a first plane that is the same as the plane of the Figure and shows the spread part of the beam. This beam is focused by a lens 11 as will be explained hereafter so as to obtain an angle β of around 1° as may be seen in FIG. 4 along a second plane perpendicular to the first. This focusing according to the invention enables the dimensions of the beam and thus the reflective surface to be reduced. FIG. 2 once again shows the combination of two electroluminescent diodes 8 and 8′ placed at a distance from one another and emitting two beams 9 and 9′, each at a useful angle of 8°. When the reflected beam is received by a sensor, a combination of these two beams is obtained, as can be seen in FIG. 3. Thus, by using two electroluminescent diodes 8 and 8′, a beam 9″ is obtained from a diode 8″ which would be unique at a reception angle equivalent to double that of each sensor, equal to 16° in the example described. FIG. 2 shows a specific arrangement of the two electroluminescent diodes on a support 10 constituted by two inclined joined parts. This incline enables the performances to be evened out at the centre and edge of the reflected beam.

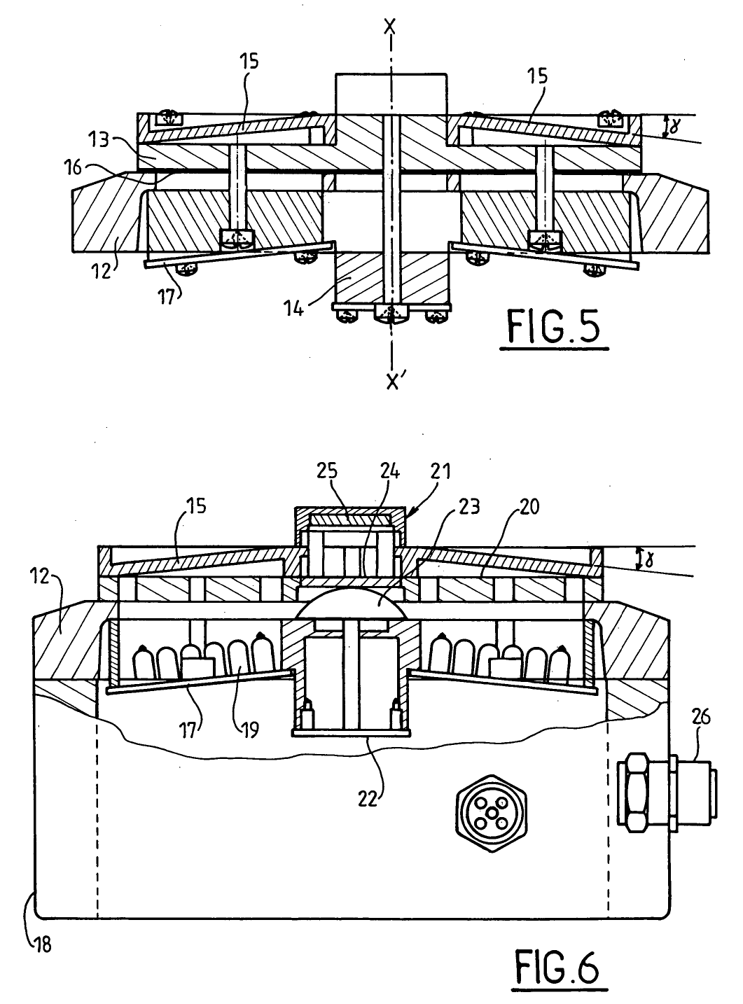

FIG. 5, which is a section of an actual embodiment of the invention, shows the lid 12 of a case described with reference to FIG. 6, onto which an external plate 13 and internal plate have been fastened. On the external plate 13, a lens support 15 is fastened whose plane surface is inclined on both sides of the median plane passing along axis XX′. The angle of inclination γ is of around 1° to 6°. A seal 16 positioned between the support 15 and the plate 13 makes the assembly of these two parts watertight. The internal plate 14 also receives a support 17 onto which the electroluminescent diodes will be fastened. The assembly formed by these parts is fixed using screws.

FIG. 6 shows a section of a case 18 incorporating the assembly of elements constituting the device according to the invention onto which the lid 12 is fixed. This case is substantially parallelepipedic in shape. The support 17 is in the form of an electronic board carrying the electroluminescent diodes 19 arranged, in the present case, in six rows. Two groups of electroluminescent diodes are arranged in this case so as to combine the light beams as explained previously with reference to FIG. 3. These two groups of electroluminescent diodes constitute emission means 3 whose advantages have been explained with reference to FIG. 3. The electronic board is position in parallel to the support 15 and is thus inclined at the same angle γ as this support 15. This inclination enables the beam reflected perpendicularly to the immobile object to be eliminated preventing the sensor from being overloaded. Between the support 15 and the lid 12 a filter 20 is positioned which is intended to fix the wavelength of the electroluminescent diodes 19. The reception means 21 constituted by a photodiode 22, a focusing lens 23, a filter 24 and an optional protective window 25 are fastened in the central part of the case 18. The Figure shows the connector 26 connecting the case to the electrical power supply. The case can be made fully watertight so as to withstand saline corrosion. Naturally, lugs are provided for its attachment to the mobile object.

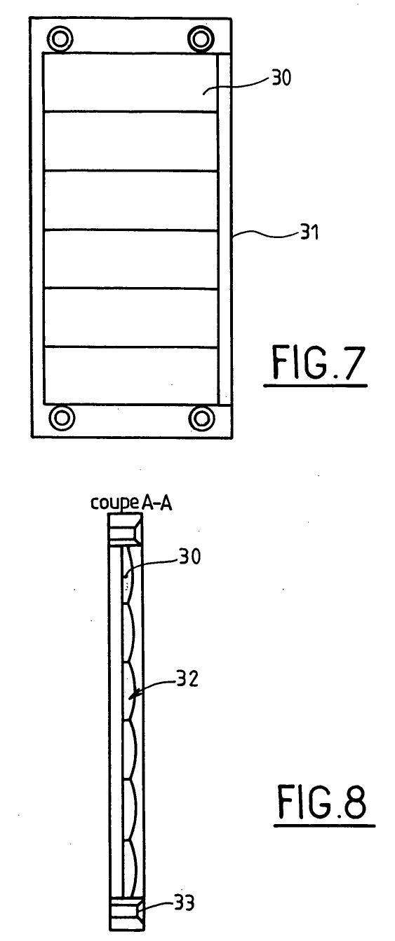

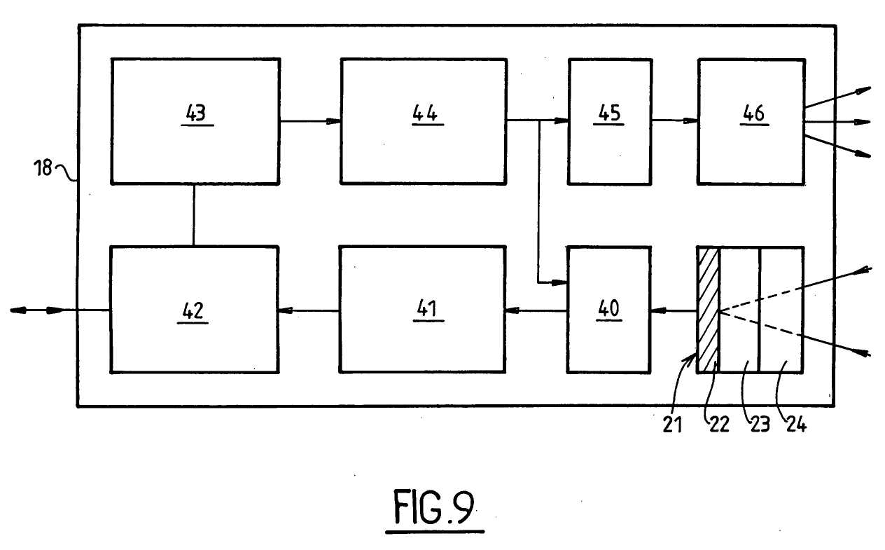

FIGS. 7 and 8 show the embodiment of the semi-cylindrical lens 30 in the form of a board 31. These lenses 30 are molded joined together with a domed face 32 so as to concentrate the beam. Advantageously, the board 31 is made of a transparent plastic material. The plate is provided with perforations 33 to enable it to be attached to its support 15.

FIG. 9 shows a block diagram of the components of the case 18 in which all the components are inserted. The receiver means 21 are constituted, as indicated previously, of the photodiode 22, the focusing lens 23 and the filter 24. This assembly constitutes a linear photodiode sensor. The means 21 constitute the viewing organ of the device according to the invention. They enable an alignment of points focused by the lens 23 to be examined in order to scan a wide enough field of around 10°. The filter 24 is a band pass filter centered on the wavelength of the emission module 46. The light beam received is directed toward a module 40 or illuminator, whose purpose is to digitalize its profile. The electrical signal produced is transferred into a computer 41 which analyses this signal so as to analyze the dark or opaque bands of light reflection of the immobile object and thereby determine the edge of said object. Modules 40 and 41 constitute means to analyze the reflected beam. The data delivered is then transmitted to a communication module 42 enabling information to be exchanged with the operator. As output, this module 42 will give the result of the computation performed, the errors detected by the sensor, the present and state of this sensor. As input, this module 42 receives the synchronization signal with all the sensors arranged on the mobile object, the computation parameter adaptation signal for the atmospheric conditions and the specific configuration commands from the operator. These elements are supplied with electric power by a supply module 43, for example in 24 Volt continuous current. Module 43 also powers a synchronous detection control module 44 to synchronize the light emission of the illuminator module 46. This illumination module 46 groups the boards 31 of infrared electroluminescent diodes with the same wavelength as the filter 24. A pulser module 45 whose purpose is to pulse-supply module 46 is inserted between modules 44 and 46 thereby avoiding a constant supply to the diodes 19. As illustrated in the Figure, modules 45 and 40 are synchronized by module 44.

It is possible for modules 43, 42, 41, 40, 44, 45 to be grouped on a single electronic board. Module 21 is in the form of a mechanical drum to which the filter 24 and lens 23 are bonded.

The device according to the invention operates as follows. The electroluminescent diodes 19 emit a beam of pulsed infrared light which reflects off the immobile object below and substantially vertically to the beam. The light beam may be off the surface of the immobile object, or else be fully on it, or else overlap it, that is to say at the edge of the object. Analysis of the reflected beam by module 41 enables the position of the device to be known, and thus that of the mobile object, with respect to the immobile object. The edge of the immobile object is seen as a transition from a very light zone to a very dark zone. By coupling the data coming from several devices, it is easy to control the position of the mobile object with respect to the immobile object.

What is claimed is:

1. A device to determine the position of a mobile object with respect to an immobile object, wherein said device comprises first means to emit a beam of infrared light fixed on said mobile object to illuminate at least partially said immobile object, second means to receive the reflected beam fixed onto said mobile object and third means to analyze said reflected beam to delimit its variations in intensity.

2. A device according to claim 1, wherein said first means are constituted by at least one electroluminescent diode whose beam is focused.

3. A device according to claim 2, wherein said beam of said electroluminescent diode is focused using a semi-cylindrical lens.

4. A device according to claim 2, wherein said first means are constituted by a set of said electroluminescent diode strips positioned in parallel to one another, a set of lenses being associated with said electroluminescent diodes.

5. A device according to claim 4, wherein said set of said electroluminescent diodes is integral with a support inclined at an angle γ with respect to a horizontal direction delimited by said immobile object, said set of lenses being inclined by the same angle.

6. A device according to claim 5, wherein said device comprises a set of said electroluminescent diode strips ranged on both sides of said reception means.

7. A device according to claim 1, wherein said reception means are constituted by a linear photodiode sensor.

8. A device according to claim 7, wherein said sensor is provided with reception and filtering modules centered on the wavelength of said first means.

9. A device according to claim 1, wherein said third means to analyze said reflected beam are able to spot zones of differing light intensity to detect the presence of said immobile object and its position.

10. A device according to claim 1, wherein said first means are supplied by pulse so as to illuminate said immobile object intermittently.

11. A process to implement a device to determine the position of a mobile object with respect to an immobile object, wherein said immobile object is illuminated by means of electroluminescent diodes, the reflected beam is analyzed so as to determine the bands of differing luminosity, the zones of strong luminosity representing the data of the presence of said immobile object are determined, said data is stored in a memory, and the same steps are repeated at several representative points of said immobile object.

12. A process according to claim 11, wherein said immobile object is a container and said mobile object is a spreader in the form of a frame whose dimensions are adapted to those of said container side facing it and wherein a device according to claim 1 is placed on each side of said frame.
